(19) United States
(12) Patent Application Publication
(10) Pub. No.: US 2005/0070436 A1
(43) Pub. Date: Mar. 31, 2005

(54) Growth stimulating composition for plants

(75) Inventors: Jose Maria Garcia-Mina Freire, Navarra (ES); Santiago Cenoz Imaz, Navarra (ES)

Correspondence Address: John Palmer;c/o LADAS & PARRY, Suite 2100, 5670 Wilshire Boulevard, Los Angeles, CA, 90036-5679, US

(73) Assignee: INABONOS S.A.

(21) Appl. No.: 10/903,238

(22) Filed: Jul. 30, 2004

Related U.S. Application Data
(62) Division of application No. 09/829,779, filed on Apr. 10, 2001, now abandoned.

(30) Foreign Application Priority Data
Apr. 13, 2000 (ES) P200000968

(51) Int. Cl. A01N 63/00; A01N 57/00; A01N 43/40

(52) U.S. Cl. 504/117; 504/127

(57) ABSTRACT

It consists of using a precursor compound of cyclic AMP, or an inhibitor compound of the enzymes of the Phosphodiesterases family, or a stimulating compound of the enzymes of the Adenyl-Cyclase family, or an agonist compound of the β-adrenergic receptors to which arachidonic acid or a prostaglandin is added. The composition object of the invention can be presented mixed with mineral fertilizers (such as amonic nitrate, monopotassium phosphate, etc.), with phytoregulators (such as cytoquinines, auxines, giberelines, polyamines, n-ethanolamines, sugars . . . ) or with any type of phytosanitary product (such as fungicides, herbicides etc.). The composition object of the invention can be formulated with tensoactive agents (such as Tween 80), moistening agents etc. The composition object of the invention can be applied to any species of plant and at any point in its life cycle.

The present invention refers to a product with the capacity to increase the intra-cellular levels of cyclic AMP as stimulants of plant growth and development in normal conditions and in conditions of stress (osmotic, hydric, thermic, mechanical or pathogenic attack). It can be applied to any species of plant and at any point in its life cycle.

Although the intervention of cyclic AMP (3′-5′-adenosine cyclic monophosphate) is well-known as an intra-cellular regulator of a great number of biochemical processes in animals (Khan y Lands, 1973. Prostaglandins and cyclic AMP. Academic Press), the role that this compound may represent in the regulation of biochemical processes in plant cells is far from being well-known and even its existence in this medium is disputed (Newton, R., and col., Cyclic nucleotides in higher plants: the enduring paradox. New Phytol., 143, 427-455., 1999).

The effect of the intra-cellular levels of cyclic AMP on the growth of plants in stress conditions and normal conditions has been investigated. The stress states include osmotic or saline stress, hydric stress, thermic stress, mechanical stress and stress caused by the attack of exterior agents (pathogenic agents like, for example, fungi, bacterias, insects, viruses, etc).

At this present time, some patent documents are known which describe the use of nucleotides to improve germination and primary development of seedlings.

In this way, in document U.S. Pat. No. 4,209,316 (McDaniel and Brooks; 1978), it is not specified if they are cyclic nucleotides and furthermore the use of stimulants is not contemplated in the intra-cellular content of cyclic AMP but in the nucleotides themselves. Moreover, neither do they refer to adult plants in production but to seedlings in their primary states.

Document U.S. Pat No. 4,050,919 (Motomura, Y and Ishiyama, J. 1975) refers to the direct application of cyclic AMP and not products which act on the intra-cellular content of cyclic AMP.

The same applies to other known patent documents, like for example document JP63279722A (Tanimoto Kiyoshi, Takahashi Shigeru; 1987) where it describes the application of cyclic AMP in culture media for the development of seedlings In vitro. Nevertheless, the application of cyclic AMP directly presents major problems due to the reduced capacity of this molecule to penetrate through the biological membranes (Khan and Lands, 1973. Prostaglandins and cyclic AMP. Academic Press), making its effectiveness (in animal models too) very low.

One objective of the present invention is to have a compound to stimulate the growth of plants which can be used in any type of plant and at any point in its life cycle.

Another objective of the present invention is to have a compound to stimulate plant growth which is effective both in normal conditions and in stress situations (osmotic, hydric, thermic, mechanical or pathogenic attack).

The invention basically consists of using a precursor compound of cyclic AMP, or an inhibitor compound of the enzymes of the phosphodiesterases family, or a stimulator compound of the enzymes of the Adenyl-Cyclase, or an agonist compound of the β-adrenergic receptors to which arachidonic acid or a prostaglandin is added.

The advantages which the product object of the invention presents with respect to the state of the technique lie in:
Its composition, since compounds are used (different from cyclic AMP) with the capacity to increase the intra-cellular content of cyclic AMP in different species of plants, thus stimulating its plant development. None of the products specified have been previously described for this use in plants.
Its use, since the product object of the invention is prepared for the treatment of adult plants in production. The known patent documents only refer to culture media in relation to the production of plants in vitro, seed germination or primary development of seedlings.
The conditions of use, since the product object of the invention is active on adult plants both under normal conditions, and under stress conditions (saline, osmotic, hydric, mechanical or caused by pathogen agents).

A preferred embodiment of the composition object of the invention comprises one or several of the following components;

A precursor compound of cyclic AMP for its transformation to the latter in the interior of the cells., such as the by-product Dibutiril-cyclic AMP. The optimum dosage interval is between 0.1 and 2 ppm, via radicular or foliar.

A compound with the capacity of inhibiting the activity of the enzymes of the phosphodiesterases family, such as theophylline, theobromine or caffeine. The optimum dosage interval is between 0.5 and 10 ppm, via radicular or foliar.

A compound with the capacity to stimulate the activity of the enzymes of the Adenyl-Cyclase, such as forskolin. The optimum dosage interval is between 0.1 and 2 ppm, via radicular or foliar.

An agonist compound of the β-adrenergic receptors such as isoproterenol, epinephrine (adrenaline) or norepinephrine (noradrenaline). The optimum dosage interval is between 1 and 100 ppm, via radicular or foliar.

A chosen compound between arachidonic acid or a prostaglandin. The optimum dosage interval is between 0.25 and 100 ppm, via radicular or foliar.

As for the applicability of the composition object of the invention it can be brought into practice at great liberty.

The composition object of the invention can be applied in solid form, liquid form or suspension. The composition object of the invention can be applied to any species of plant and at any point in its life cycle. The optimum time of application is:
Via foliar or radicular in annual plants (cereal, horticultural, . . . ): commence treatment on transplant or with 3-4 green leaves.
In woody perennials commence treatment after budding, and before flowering.

The composition object of the invention can be applied by via radicular or foliar. The optimum dosage interval is between 5 and 10 litres or kilos per hectare. When applied in solution, the optimum dilution is 0.5%.

The composition object of the invention can be presented mixed with mineral fertilizers (such as amonic nitrate, monopotassium phosphate, etc.), with phytoregulators (such as cytoquinines, auxines, giberelines, polyamines, n-ethanolamines, sugars . . . ) or any type of phytosanitary product (such as fungicides, herbicides, etc.). The proportion of each compound in the mixture can vary between:
1-25% for fertilizers
0.5-5% phytoregulators
1-20% phytosanitaries.

The composition object of the invention can be formulated with tensoactive agents, such as Tween 80 etc., moistening agents etc. The proportions of the mixture of each compound can vary between:
0.1%-10% tensoactive.
1-10% moistening agents.

### EXAMPLE

Composition for 1 kg of product:
1. 0.5 g of Forskolin
2. 1 g of caffeine
3. 0.2 g of 6-Bencilaminopurina
4. 200 g of dipotassium phosphate
5. 45 g of urea
6. 753.3 g of water

Order of making:
Continuous stirring and environment temperature (20-25° C.)
1. (6)+(4)+(5). Stirring until completely dissolved.
2. 1.+(1)+(2)+(3).

Effect of different compounds on the development of vine plants affected by an attack of mildew (plamopara viticola).

A random block assay was carried out with four repetitions per treatment including 10 vines per repetition.

The disease caused by the plamopara viticola fungus was evaluated both in the expression of frequency (number of leaves affected) and of intensity (percentage of leaf surface affected).

The products applied were:
Treatment A: A by-product of phosphorous acid+a contact fungicide (folpet) (4kg/hectare) (reference treatment).
Treatment B: A by-product of phosphorous acid (2.35 l/ hectare).
Treatment C: A by-product of phosphorous acid (3.25 l/ hectare)+Patent product according to example of making (2 l/ hectare).
Control which received no treatment.

The results were the following

Degree of Disease on Leaves

| | Frequency (%) | Intensity (%) |
|---|---|---|
| Treatment | (% reduction) | (% reduction) |
| Control | 12.27 a (—) | 53 a (—) |
| A | 0.5 b (96) | 4.8 b (91) |
| B | 4.7 c (62) | 25.8 c (51) |
| C | 1.85 b (85) | 11.8 b (78) |

As can be observed, the application of the product object of the patent with the capacity to increase the intra-cellular levels of cyclic AMP (product C) strengthens the action of the product of synthesis (by-product of phosphorous acid) to 23% in relation to frequency and to 27% in relation to intensity referring to the absolute value of the % of reduction.

1. Growth stimulating composition for plants characterized by comprising one or several of the following components:
a precursor compound of cyclic AMP for its transformation in the latter compound in the interior of the cells,
a compound with the capacity to inhibit the activity of the enzymes of the phosphodiesterases family,
a compound with the capacity to stimulate the activity of the enzymes of the Adenyl-Cyclase family,
an agonist compound of the β-adrenergic receptors,
a chosen compound between arachidonic acid or a prostaglandin.

2. Growth stimulating composition for plants in accordance with claim 1, characterized in that the precursor compound of cyclic AMP is Dibutiril-cyclic Amp.

3. Growth stimulating composition for plants in accordance with claim 1, characterized in that the compound with capacity to inhibit the activity of the enzymes of the phosphodiesterases family is chosen between theophylline, theobromine or caffeine.

4. Growth stimulating composition for plants in accordance with claim 1, characterized in that the compound with capacity to stimulate the activity of the enzymes of the Adenyl-Cyclase family is Forskolin.

5. Growth stimulating composition for plants in accordance with claim 1, characterized in that the agonist compound of the β-adrenergic receptors is chosen between isoproterenol, epinephrine (adrenaline) or norepinephrine (noradrenaline).

6. Growth stimulating composition for plants in accordance with claim 1, characterized in that mineral fertilizer is added.

7. Growth stimulating composition for plants in accordance with claim 6, characterized in that the mineral fertilizer is chosen between amonic nitrate or potassium phophate.

8. Growth stimulating composition for plants in accordance with claim 1, characterized in that a phytoregulator product is added.

9. Growth stimulating composition for plants in accordance with claim 8, characterized in that the phytoregulator product is chosen between cytoquinines, auxines, giberelines, polyamines, n-ethanolamines or sugars.

10. Growth stimulating composition for plants in accordance with claim 1, characterized in that a phytosanitary product is added.

11. Growth stimulating composition for plants in accordance with claim 10, characterized in that the phytosanitary product is chosen between a fungicide or a herbicide.

12. Growth stimulating composition for plants in accordance with claim 1, characterized in that a tensoactive agent is added.

13. Growth stimulating composition for plants in accordance with claim 12, characterized in that the tensoactive agent is Tween 80.

14. Growth stimulating composition for plants in accordance with claim 1, characterized in that a moistening agent is added.
